(19) United States
(12) Patent Application Publication
(10) Pub. No.: US 2017/0212258 A1
(43) Pub. Date: Jul. 27, 2017

(54) HYDROPHONE

(71) Applicant: Lockheed Martin Corporation, Bethesda, MD (US)

(72) Inventor: Bryan Neal Fisk, Madison, AL (US)

(73) Assignee: Lockheed Martin Corporation, Bethesda, MD (US)

(21) Appl. No.: 15/003,177

(22) Filed: Jan. 21, 2016

(51) Int. Cl. G01V 1/18; G01V 1/38

(52) U.S. Cl. CPC G01V 1/186; G01V 1/3808

(57) ABSTRACT

A system includes an acoustic transmitter and a magnetometer. The acoustic transmitter is configured to transmit an acoustic signal through a fluid with dissolved ions. The magnetometer is configured to detect the acoustic signal through the fluid. In some embodiments, such as in a passive sonar application, the system does not include a transmitter.

### CROSS-REFERENCE TO RELATED APPLICATIONS

The present application is related to co-pending U.S. application Ser. No. ______, filed Jan. 21, 2016, titled “DIAMOND NITROGEN VACANCY SENSED FERRO-FLUID HYDROPHONE,” Atty. Dkt. No. 111423-1072, which is incorporated by reference herein in its entirety.

### TECHNICAL FIELD

The present disclosure relates, in general, to hydrophones. More particularly, the present disclosure relates to using a magnetometer as a hydrophone.

### BACKGROUND

The following description is provided to assist the understanding of the reader. None of the information provided or references cited is admitted to be prior art. Some hydrophones use a sensor that is compressed or otherwise physically affected by sound waves. For example, piezoelectric sensors can be used to measure the compression of a quartz material caused by sound waves. However, sound waves do not propagate well through interfaces of differing materials. For example, sound waves lose much of their energy when transitioning from water to a solid material such as a piezoelectric sensor. Thus, a more efficient hydrophone may be helpful.

### SUMMARY

An illustrative system includes an acoustic transmitter and a magnetometer. The acoustic transmitter may be configured to transmit an acoustic signal through a fluid with dissolved ions. The magnetometer may be configured to detect the acoustic signal through the fluid.

An illustrative system includes an acoustic transmitter and an array of magnetometers. The acoustic transmitter may be configured to transmit an acoustic signal through a fluid with dissolved ions. The array of magnetometers may be configured to detect the acoustic signal through the fluid.

An illustrative method includes transmitting an acoustic signal through a fluid with dissolved ions. The method may further include detecting, using a magnetometer, the acoustic signal.

An illustrative device includes a magnetometer that is configured to determine a characteristic of an acoustic signal. The acoustic signal may travel through a fluid with dissolved ions.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 illustrates one orientation of an NV center in a diamond lattice in accordance with an illustrative embodiment.

FIG. 2 is an energy level diagram illustrates energy levels of spin states for the NV center in accordance with an illustrative embodiment.

FIG. 3 is a schematic illustrating an NV center magnetic sensor system in accordance with an illustrative embodiment.

FIG. 4 is a graph illustrating the fluorescence as a function of applied RF frequency of an NV center along a given direction for a zero magnetic field and a non-zero magnetic field in accordance with an illustrative embodiment.

FIG. 5 is a graph illustrating the fluorescence as a function of applied RF frequency for four different NV center orientations for a non-zero magnetic field in accordance with an illustrative embodiment.

FIG. 6 is a schematic illustrating an NV center magnetic sensor system in accordance with some illustrative implementations in accordance with an illustrative embodiment.

FIGS. 7A and 7B are diagrams illustrating hydrophone systems in accordance with illustrative embodiments.

FIG. 8 is a block diagram of a computing device in accordance with an illustrative embodiment.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Nitrogen-vacancy (NV) centers are defects in a diamond's crystal structure. Synthetic diamonds can be created that have these NV centers. NV centers generate red light when excited by a light source, such as a green light source, and microwave radiation. When an excited NV center diamond is exposed to an external magnetic field the frequency of the microwave radiation at which the diamond generates red light and the intensity of the light change. By measuring this change and comparing the change to the microwave frequency that the diamond generates red light at when not in the presence of the external magnetic field, the external magnetic field strength can be determined. Accordingly, NV centers can be used as part of a magnetic field sensor.

In various implementations, microwave RF excitation is needed in a DNV sensor. The more uniform the microwave signal is across the NV centers in the diamond the better and more accurate an NV sensor will perform. Uniformity, however, can be difficult to achieve. Also, the larger the bandwidth of the element, the better the NV sensor will perform. Large bandwidth, such as octave bandwidth, however, can be difficult to achieve. Various NV sensors respond to a microwave frequency that is not easily generated by RF antenna elements that are comparable to the small size of the NV sensor. In addition, RF elements should reduce the amount of light within the sensor that is blocked by the RF elements. When a single RF element is used, the RF element is offset from the NV diamond when the RF element maximized the faces and edges of the diamond that light can enter or leave. Moving the RF element away from the NV diamond, however, impacts the uniformity of strength of the RF that is applied to the NV diamond.

The present inventors have realized that a configuration of RF elements can provide both the magnetic bias and the RF field for a DNV magnetic system. The magnetic bias provided by various implementations can be a uniform magnetic field along three polarizations of the axes of the coils used in various implementations. As described in greater detail below, using the various configuration of RF elements in a DNV sensor can allow greater access to the edges and faces of the diamond for light input and egress, while also providing a relatively uniform field in addition to a bias magnetic field. In various implementations, a NV diamond is contained within a housing. The housing can have six sides, each side operating as an RF element to apply a uniform RF field to the NV diamond. In addition, the six RF elements can also provide the magnetic bias for the NV sensor. Further, the six sides can be configured to allow various different configurations for light ingress and egress. The spacing and size of the RF elements allow for all edges and faces of the diamond to be used for light ingress and egress. The more light captured by photo-sensing elements of a DNV senor results in an increased efficiency of the sensor. In addition, the multiple polarization RF field of various implementations can increase the number of NV centers that are efficiently excited. In addition, the multiple polarization RF field can be used to differentially control the polarizations to achieve higher order functionality from the DNV sensor.

Hydrophones can be used in many applications. For example, hydrophones can be used in sonar applications. An acoustic signal is transmitted from a transmitter, is reflected off of a remote surface, and is detected by a hydrophone. The time that the acoustic signal travels from the transmitter to the hydrophone can be used to determine how far the surface that the acoustic signal reflected off of is from the transmitter/hydrophone. For example, the transmitter and the hydrophone can be relatively close together, such as on a vessel. In alternative embodiments, the hydrophone can be used without a transmitter. For example, passive sonar systems can use hydrophones to detect sounds made, for example, by ships, vessels, boats, mammals, fish, etc.

Hydrophones can use materials that are affected by mechanical deformation to detect acoustic signals. For example, hydrophones can use ceramics or other solid-state materials. A piezoelectric hydrophone can use a ceramic or crystalline structure. When the material is deformed or a mechanical stress is applied to the material, the material can create an electric signal. An acoustic signal can be sound waves that are compressions. As the acoustic signal travels through the material of the hydrophone, the compressions deform the material and cause the electric signal. Based on the electric signal, the acoustic signal can be determined.

Such hydrophones typically use a material that is in a solid phase, such as ceramics. When sound waves travel from one material to another, such as from water to a solid material, the sound waves can be attenuated. For example, a portion of the sound waves can be reflected off of the surface of the solid material. Accordingly, such hydrophones do not have optimum sensitivity because some of the acoustic signal is attenuated and not sensed by the hydrophone. In some instances, the attenuation results in unintended filtering of the signal because some of the acoustic signal frequency is unrecoverable due to signal refraction. In some embodiments, such hydrophones have reduced sensitivity to acoustic signals with an incident angle that is less than ninety degrees to the hydrophone. That is, such hydrophones may have difficulty detecting acoustic signals that travel at an angle less than ninety degrees to the hydrophone due to refraction and defraction of the acoustic signal through the solid material. In some instances, such hydrophones have an upper limit of frequency of the acoustic signal that can be reliably detected.

In an illustrative embodiment, a magnetometer can be used as a hydrophone. For example, a magnetometer including a diamond with NV centers can be used as a hydrophone. As explained in greater detail below, magnetometers with such diamonds have a high degree of sensitivity compared to alternative magnetometers. In alternative embodiments, any suitable magnetometer can be used.

Sea water generally contains dissolved ions, such as salt. Movement of the ions in the presence of a magnetic field (e.g., the Earth's magnetic field) create their own magnetic field. As mentioned above, acoustic signals include a compression of the material through which the signals travel. In an illustrative embodiment, acoustic signals traveling through fluid that contains ions, such as sea water, cause the ions to move. Such movement in the presence of a magnetic field such as the Earth's magnetic field creates another magnetic field that can be sensed by a magnetometer. Thus, by monitoring the magnetic field generated by the ions moving because of an acoustic signal, the magnetometer can be used as a hydrophone. In such an embodiment, the characteristics of the acoustic wave (e.g., magnitude, frequency, etc.) are detectable in the magnetic field created by the moving ions.

Although use of a hydrophone in sea water is described herein, any suitable fluid with dissolved ions can be used. Also, any suitable magnetic source can be used to cause the moving ions to create their own magnetic field. For example, a magnetic source such as a permanent magnet or an electromagnet can be used to generate a magnetic field in which the ions move. In alternative embodiments, the Earth's magnetic field can be used.

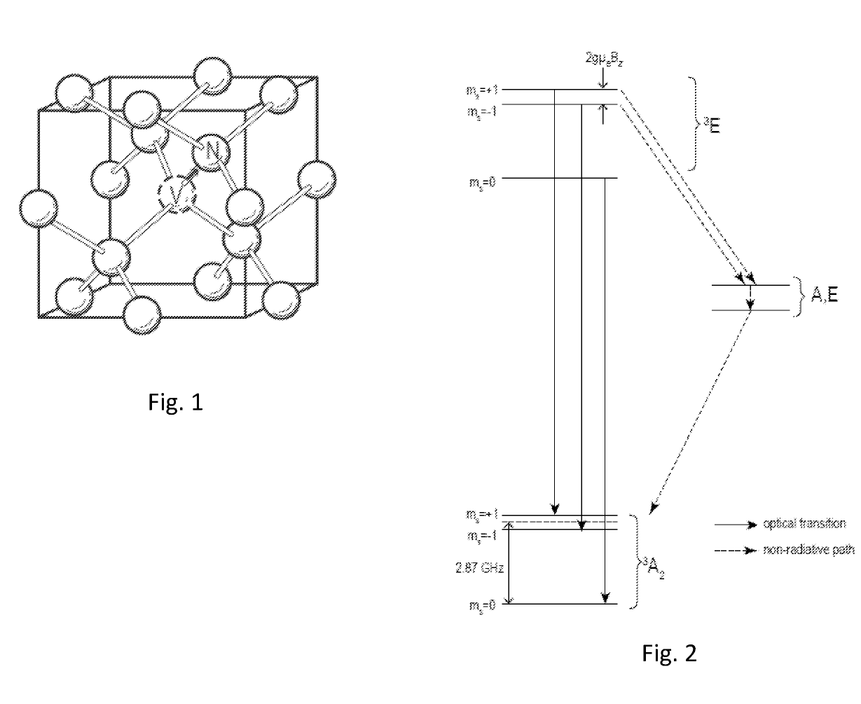

The nitrogen vacancy (NV) center in diamond comprises a substitutional nitrogen atom in a lattice site adjacent a carbon vacancy as shown in FIG. 1. The NV center may have four orientations, each corresponding to a different crystallographic orientation of the diamond lattice.

The NV center may exist in a neutral charge state or a negative charge state. Conventionally, the neutral charge state uses the nomenclature NV0, while the negative charge state uses the nomenclature NV, which is adopted in this description.

The NV center has a number of electrons including three unpaired electrons, each one from the vacancy to a respective of the three carbon atoms adjacent to the vacancy, and a pair of electrons between the nitrogen and the vacancy. The NV center, which is in the negatively charged state, also includes an extra electron.

The NV center has rotational symmetry, and as shown in FIG. 2, has a ground state , which is a spin triplet with 3A2 symmetry with one spin state ms=0, and two further spin states ms=+1, and ms=−1. In the absence of an external magnetic field, the ms=±1 energy levels are offset from the ms=0 due to spin-spin interactions, and the ms=±1 energy levels are degenerate, i.e., they have the same energy. The ms=0 spin state energy level is split from the ms=±1 energy levels by a photon energy of 2.87 GHz for a zero external magnetic field.

Introducing an external magnetic field with a component along the NV axis lifts the degeneracy of the ms=±1 energy levels, splitting the energy levels ms=±1 by an amount 2gμBBz, where g is the g-factor, μB is the Bohr magneton, and Bz is the component of the external magnetic field along the NV axis.

The NV center electronic structure further includes an excited triplet state 3E with corresponding ms=0 and ms=±1 spin states. The optical transitions between the ground state 3A2 and the excited triplet 3E are spin conserving, meaning that the optical transitions are between initial and final states which have the same spin. For a direct transition between the excited triplet 3E and the ground state 3A2, a photon of red light is emitted with a photon energy corresponding to the energy difference between the energy levels of the transitions.

There is, however, an alternate non-radiative decay route from the triplet 3E to the ground state 3A2 via intermediate electron states, which are thought to be intermediate singlet states A, E with intermediate energy levels. Significantly, the transition rate from the ms=±1 spin states of the excited triplet 3E to the intermediate energy levels is different than that from the ms=0 spin state of the excited triplet 3E to the intermediate energy levels. The transition from the singlet states A, E to the ground state triplet 3A2 has approximately an equal probability of decay to either of the ms=0 spin state and the ms=±1spin states. These features of the decay from the excited triplet 3E state via the intermediate singlet states A, E to the ground state triplet 3A2 allows that if optical excitation is provided to the system, the optical excitation will eventually pump the NV center into the ms=0 spin state of the ground state 3A2. In this way, the population of the ms=0 spin state of the ground state 3A2 may be “reset” to a maximum polarization determined by the decay rates from the triplet 3E to the intermediate singlet states.

Another feature of the decay is that the fluorescence intensity due to optically stimulating the excited triplet 3E state is less for the ms=±1 states than for the ms=0 spin state. This is so because the decay via the intermediate states does not result in a photon emitted in the fluorescence band, and because of the greater probability that the ms=±1 states of the excited triplet 3E state will decay via the non-radiative decay path. The lower fluorescence intensity for the ms=±1 states than for the ms=0 spin state allows the fluorescence intensity to be used to determine the spin state. As the population of the ms=±1 states increases relative to the ms=0 spin, the overall fluorescence intensity will be reduced.

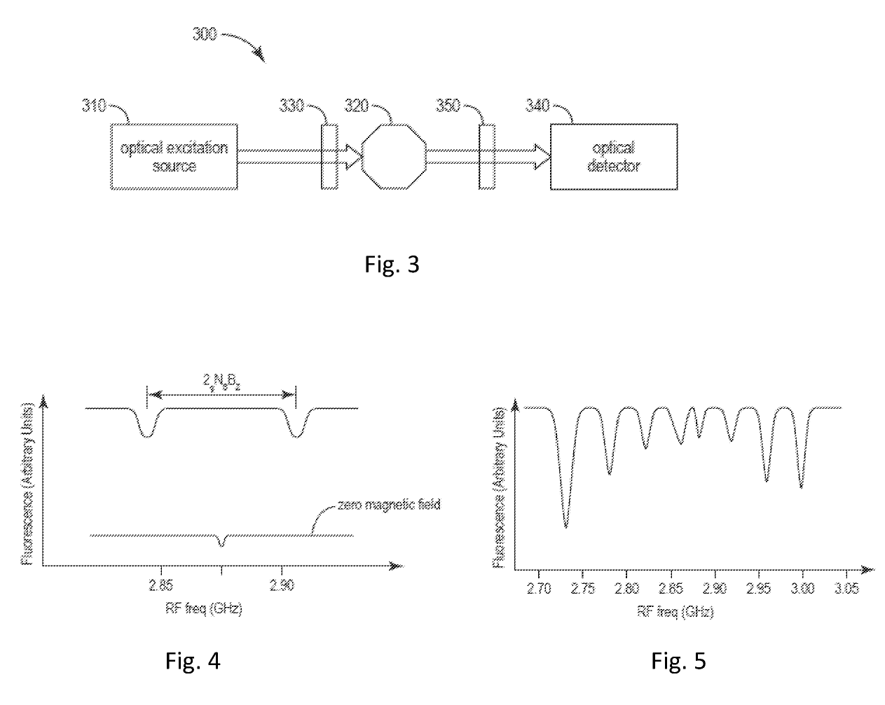

FIG. 3 is a schematic illustrating an NV center magnetic sensor system 300 which uses fluorescence intensity to distinguish the ms=±1 states, and to measure the magnetic field based on the energy difference between the ms=+1 state and the ms=−1 state. The system 300 includes an optical excitation source 310, which directs optical excitation to an NV diamond material 320 with NV centers. The system 300 further includes an RF excitation source 330 which provides RF radiation to the NV diamond material 320. Light from the NV diamond may be directed through an optical filter 350 to an optical detector 340.

The RF excitation source 330 may be a microwave coil, for example. The RF excitation source 330 when emitting RF radiation with a photon energy resonant with the transition energy between ground ms=0 spin state and the ms=+1 spin state excites a transition between those spin states. For such a resonance, the spin state cycles between ground ms=0 spin state and the ms=+1 spin state, reducing the population in the ms=0 spin state and reducing the overall fluorescence at resonance. Similarly resonance occurs between the ms=0 spin state and the ms=−1 spin state of the ground state when the photon energy of the RF radiation emitted by the RF excitation source is the difference in energies of the ms=0 spin state and the ms=−1 spin state. At resonance between the ms=0 spin state and the ms=−1 spin state, or between the ms=0 spin state and the ms=+1 spin state, there is a decrease in the fluorescence intensity.

The optical excitation source 310 may be a laser or a light emitting diode, for example, which emits light in the green, for example. The optical excitation source 310 induces fluorescence in the red, which corresponds to an electronic transition from the excited state to the ground state. Light from the NV diamond material 320 is directed through the optical filter 350 to filter out light in the excitation band (in the green for example), and to pass light in the red fluorescence band, which in turn is detected by the detector 340. The optical excitation light source 310, in addition to exciting fluorescence in the diamond material 320, also serves to reset the population of the ms=0 spin state of the ground state 3A2 to a maximum polarization, or other desired polarization.

For continuous wave excitation, the optical excitation source 310 continuously pumps the NV centers, and the RF excitation source 330 sweeps across a frequency range which includes the zero splitting (when the ms=±1 spin states have the same energy) photon energy of 2.87 GHz. The fluorescence for an RF sweep corresponding to a diamond material 320 with NV centers aligned along a single direction is shown in FIG. 4 for different magnetic field components Bz along the NV axis, where the energy splitting between the ms=−1 spin state and the ms=+1 spin state increases with Bz. Thus, the component Bz may be determined. Optical excitation schemes other than continuous wave excitation are contemplated, such as excitation schemes involving pulsed optical excitation, and pulsed RF excitation. Examples, of pulsed excitation schemes include Ramsey pulse sequence, and spin echo pulse sequence.

In general, the diamond material 320 will have NV centers aligned along directions of four different orientation classes. FIG. 5 illustrates fluorescence as a function of RF frequency for the case where the diamond material 320 has NV centers aligned along directions of four different orientation classes. In this case, the component Bz along each of the different orientations may be determined. These results along with the known orientation of crystallographic planes of a diamond lattice allow not only the magnitude of the external magnetic field to be determined, but also the direction of the magnetic field.

While FIG. 3 illustrates an NV center magnetic sensor system 300 with NV diamond material 320 with a plurality of NV centers, in general the magnetic sensor system may instead employ a different magneto-optical defect center material, with a plurality of magneto-optical defect centers. The electronic spin state energies of the magneto-optical defect centers shift with magnetic field, and the optical response, such as fluorescence, for the different spin states is not the same for all of the different spin states. In this way, the magnetic field may be determined based on optical excitation, and possibly RF excitation, in a corresponding way to that described above with NV diamond material.

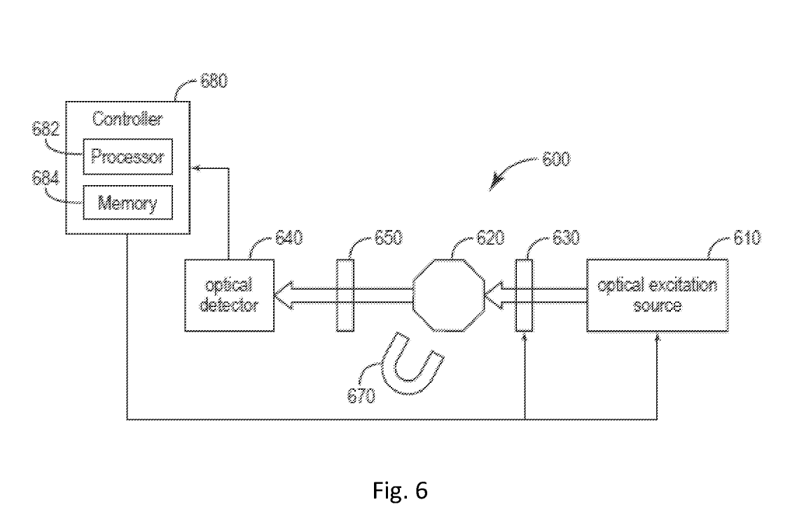

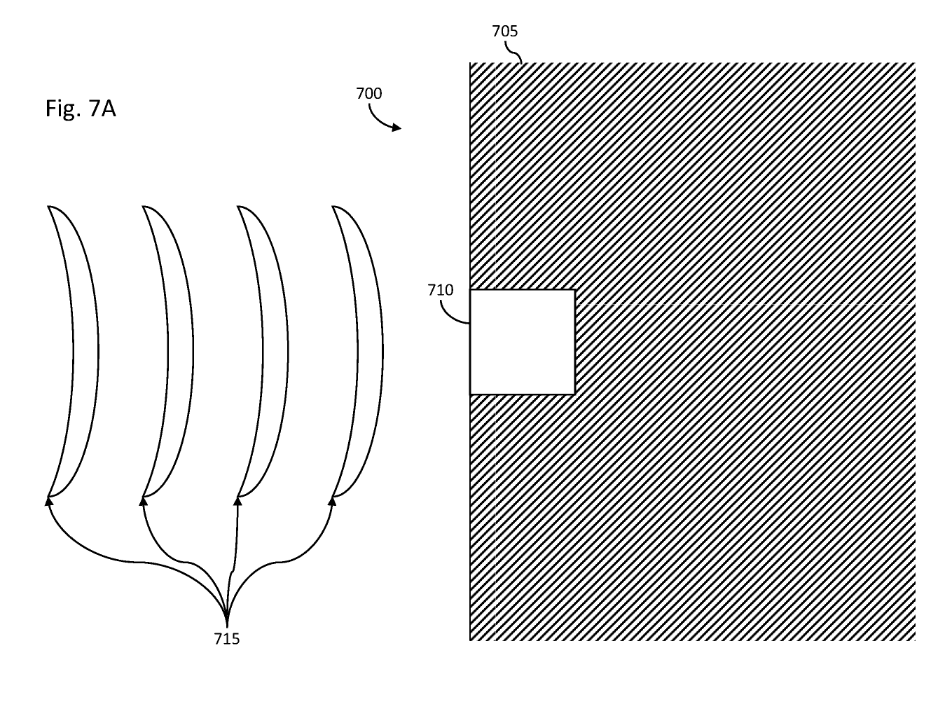

FIG. 6 is a schematic of an NV center magnetic sensor 600, according to an embodiment of the invention. The sensor 600 includes an optical excitation source 610, which directs optical excitation to an NV diamond material 620 with NV centers, or another magneto-optical defect center material with magneto-optical defect centers. An RF excitation source 630 provides RF radiation to the NV diamond material 620. The NV center magnetic sensor 600 may include a bias magnet 670 applying a bias magnetic field to the NV diamond material 620. Light from the NV diamond material 620 may be directed through an optical filter 650 and an electromagnetic interference (EMI) filter 660, which suppresses conducted interference, to an optical detector 640. The sensor 600 further includes a controller 680 arranged to receive a light detection signal from the optical detector 640 and to control the optical excitation source 610 and the RF excitation source 630.

The RF excitation source 630 may be a microwave coil, for example. The RF excitation source 630 is controlled to emit RF radiation with a photon energy resonant with the transition energy between the ground ms=0 spin state and the ms=±1 spin states as discussed above with respect to FIG. 3.

The optical excitation source 610 may be a laser or a light emitting diode, for example, which emits light in the green, for example. The optical excitation source 610 induces fluorescence in the red, which corresponds to an electronic transition from the excited state to the ground state. Light from the NV diamond material 620 is directed through the optical filter 650 to filter out light in the excitation band (in the green for example), and to pass light in the red fluorescence band, which in turn is detected by the optical detector 640. The EMI filter 660 is arranged between the optical filter 650 and the optical detector 640 and suppresses conducted interference. The optical excitation light source 610, in addition to exciting fluorescence in the NV diamond material 620, also serves to reset the population of the ms=0 spin state of the ground state 3A2 to a maximum polarization, or other desired polarization.

The controller 680 is arranged to receive a light detection signal from the optical detector 640 and to control the optical excitation source 610 and the RF excitation source 630. The controller may include a processor 682 and a memory 684, in order to control the operation of the optical excitation source 610 and the RF excitation source 630. The memory 684, which may include a nontransitory computer readable medium, may store instructions to allow the operation of the optical excitation source 610 and the RF excitation source 630 to be controlled.

According to one embodiment of operation, the controller 680 controls the operation such that the optical excitation source 610 continuously pumps the NV centers of the NV diamond material 620. The RF excitation source 630 is controlled to continuously sweep across a frequency range which includes the zero splitting (when the ms=±1 spin states have the same energy) photon energy of 2.87 GHz. When the photon energy of the RF radiation emitted by the RF excitation source 630 is the difference in energies of the ms=0 spin state and the ms=−1 or ms=+1 spin state, the overall fluorescence intensity is reduced at resonance, as discussed above with respect to FIG. 3. In this case, there is a decrease in the fluorescence intensity when the RF energy resonates with an energy difference of the ms=0 spin state and the ms=−1 or ms=+1 spin states. In this way the component of the magnetic field Bz along the NV axis may be determined by the difference in energies between the ms=−1 and the ms=+1 spin states.

As noted above, the diamond material 620 will have NV centers aligned along directions of four different orientation classes, and the component Bz along each of the different orientations may be determined based on the difference in energy between the ms=−1 and the ms=+1 spin states for the respective orientation classes. In certain cases, however, it may be difficult to determine which energy splitting corresponds to which orientation class, due to overlap of the energies, etc. The bias magnet 670 provides a magnetic field, which is preferably uniform on the NV diamond material 620, to separate the energies for the different orientation classes, so that they may be more easily identified.

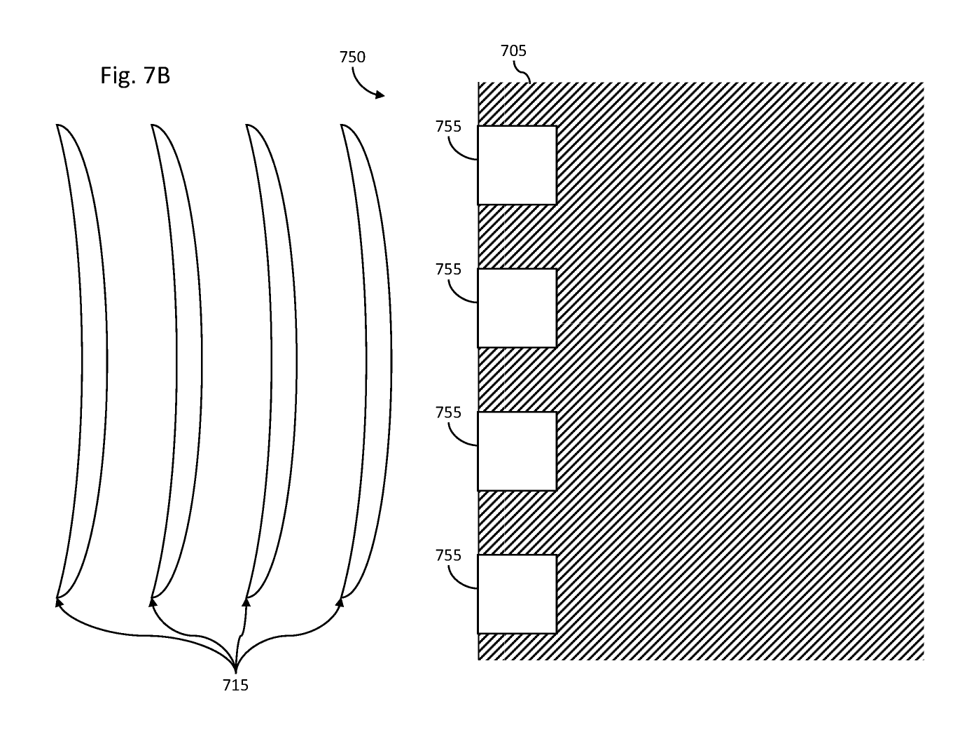

As mentioned above, a magnetometer using a diamond with NV centers can be used as a hydrophone. FIGS. 7A and 7B are diagrams illustrating hydrophone systems in accordance with illustrative embodiments. An illustrative system 700 includes a hull 705 and a magnetometer 710. In alternative embodiments, additional, fewer, or different elements can be used. For example, an acoustic transmitter can be used to generate one or more acoustic signals. In the embodiments in which a transmitter is not used, the system 700 can be used as a passive sonar system. For example, the system 700 can be used to detect sounds created by something other than a transmitter (e.g., a ship, a boat, an engine, a mammal, ice movement, etc.).

In an illustrative embodiment, the hull 705 is the hull of a vessel such as a ship or a boat. The hull 705 can be any suitable material, such as steel or painted steel. In alternative embodiments, the magnetometer 710 is installed in alternative structures such as a bulk head or a buoy.

As illustrated in FIG. 7A, the magnetometer 710 can be located within the 705. In the embodiment, the magnetometer 710 is located at the outer surface of the hull 705. In alternative embodiments, the magnetometer 710 can be located at any suitable location. For example, magnetometer 710 can be located near the middle of the hull 705, at an inner surface of the hull 705, or on an inner or outer surface of the hull 705.

In an illustrative embodiment, the magnetometer 710 is a magnetometer with a diamond with NV centers. In an illustrative embodiment, the magnetometer 710 has a sensitivity of about 0.1 micro Tesla. In alternative embodiments, the magnetometer 710 has a sensitivity of greater than or less than 0.1 micro Tesla.

In the embodiment illustrated in FIG. 7A, sound waves 715 propagate through a fluid with dissolved ions, such as sea water. As the sound waves 715 move the ions in the fluid, the ions create a magnetic field. For example, as the ions move within the magnetic field of the Earth, the ions create a magnetic field that is detectable by the magnetometer 710. In another embodiment, a magnetic field source such as a permanent magnet or an electromagnet can be used. The movement of the ions with respect to the source of the magnetic field (e.g., the Earth) creates the magnetic field detectable by the magnetometer 710.

In an illustrative embodiment, the sound waves 715 travel through sea water. The density of dissolved ions in the fluid near the magnetometer 710 depends on the location in the sea that the magnetometer 710 is. For example, some locations have a lower density of dissolved ions than others. The higher the density of the dissolved ions, the greater the combined magnetic field created by the movement of the ions. In an illustrative embodiment, the strength of the combined magnetic field can be used to determine the density of the dissolved ions (e.g., the salinity of the sea water).

In an illustrative embodiment, the hull 705 is the hull of a ship that travels through the sea water. As noted above, the movement of the ions relative to the source magnetic field can be measured by the magnetometer 710. Thus, the magnetometer 710 can be used to detect and measure the sound waves 715 as the magnetometer 710 moves through the sea water and as the magnetometer 710 is stationary in the sea water.

In an illustrative embodiment, the magnetometer 710 can measure the magnetic field caused by the moving ions in any suitable direction. For example, the magnetometer 710 can measure the magnetic field caused by the movement of the ions when the sound waves 715 is perpendicular to the hull 705 or any other suitable angle. In some embodiments, the magnetometer 710 measures the magnetic field caused by the movement of ions caused by sound waves 715 that are parallel to the surface of the hull 705.

An illustrative system 750 includes the hull 705 and an array of magnetometers 755. In alternative embodiments, additional, fewer, and/or different elements can be used. For example, although FIG. 7B illustrates four magnetometers 755 are used. In alternative embodiments, the system 750 can include fewer than four magnetometers 755 or more than magnetometers 755. The array of the magnetometers 755 can be used to increase the sensitivity of the hydrophone. For example, by using multiple magnetometers 755, the hydrophone has multiple measurement points.

The array of magnetometers 755 can be arranged in any suitable manner. For example, the magnetometers 755 can be arranged in a line. In another example, the magnetometers 755 can be arranged in a circle, in concentric circles, in a grid, etc. The array of magnetometers 755 can be uniformly arranged (e.g., the same distance from one another) or non-uniformly arranged. The array of magnetometers 755 can be used to determine the direction from which the sound waves 715 travel. For example, the sound waves 715 can cause ions near one the bottom magnetometer of the magnetometers 755 of the embodiment illustrated in the system 750 to create a magnetic field before the sound waves 715 cause ions near the top magnetometer of the magnetometers 755. Thus, it can be determined that the sound waves 715 travels from the bottom to the top of FIG. 7B.

In an illustrative embodiment, the magnetometer 710 or the magnetometers 755 can determine the angle that the sound waves 715 travel relative to the magnetometer 710 based on the direction of the magnetic field caused by the movement of the ions. For example, individual magnetometers of the magnetometers 755 can each be configured to measure the magnetic field of the ions in a different direction. Principles of beamforming can be used to determine the direction of the magnetic field. In alternative embodiments, any suitable magnetometer 710 or magnetometers 755 can be used to determine the direction of the magnetic field and/or the direction of the acoustic signal.

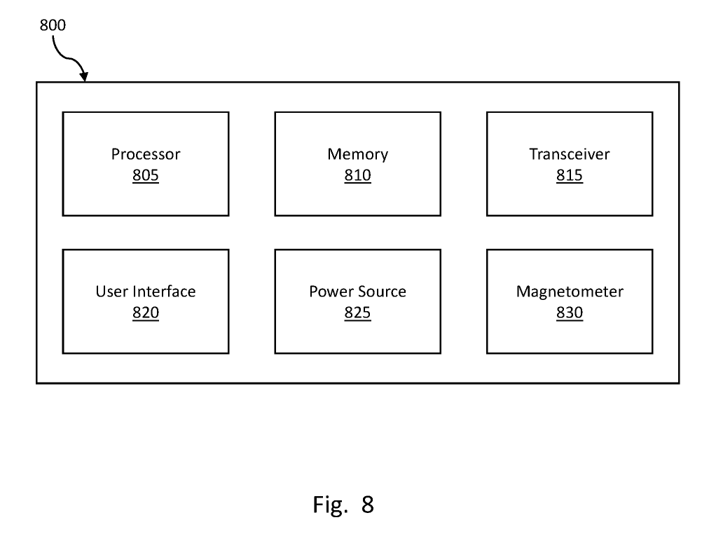

FIG. 8 is a block diagram of a computing device in accordance with an illustrative embodiment. An illustrative computing device 800 includes a memory 810, a processor 805, a transceiver 815, a user interface 820, a power source 825, and an magnetometer 830. In alternative embodiments, additional, fewer, and/or different elements may be used. The computing device 800 can be any suitable device described herein. For example, the computing device 800 can be a desktop computer, a laptop computer, a smartphone, a specialized computing device, etc. The computing device 800 can be used to implement one or more of the methods described herein.

In an illustrative embodiment, the memory 810 is an electronic holding place or storage for information so that the information can be accessed by the processor 805. The memory 810 can include, but is not limited to, any type of random access memory (RAM), any type of read only memory (ROM), any type of flash memory, etc. such as magnetic storage devices (e.g., hard disk, floppy disk, magnetic strips, etc.), optical disks (e.g., compact disk (CD), digital versatile disk (DVD), etc.), smart cards, flash memory devices, etc. The computing device 800 may have one or more computer-readable media that use the same or a different memory media technology. The computing device 800 may have one or more drives that support the loading of a memory medium such as a CD, a DVD, a flash memory card, etc.

In an illustrative embodiment, the processor 805 executes instructions. The instructions may be carried out by a special purpose computer, logic circuits, or hardware circuits. The processor 805 may be implemented in hardware, firmware, software, or any combination thereof. The term “execution” is, for example, the process of running an application or the carrying out of the operation called for by an instruction. The instructions may be written using one or more programming language, scripting language, assembly language, etc. The processor 805 executes an instruction, meaning that it performs the operations called for by that instruction. The processor 805 operably couples with the user interface 820, the transceiver 815, the memory 810, etc. to receive, to send, and to process information and to control the operations of the computing device 800. The processor 805 may retrieve a set of instructions from a permanent memory device such as a ROM device and copy the instructions in an executable form to a temporary memory device that is generally some form of RAM. An illustrative computing device 800 may include a plurality of processors that use the same or a different processing technology. In an illustrative embodiment, the instructions may be stored in memory 810.

In an illustrative embodiment, the transceiver 815 is configured to receive and/or transmit information. In some embodiments, the transceiver 815 communicates information via a wired connection, such as an Ethernet connection, one or more twisted pair wires, coaxial cables, fiber optic cables, etc. In some embodiments, the transceiver 815 communicates information via a wireless connection using microwaves, infrared waves, radio waves, spread spectrum technologies, satellites, etc. The transceiver 815 can be configured to communicate with another device using cellular networks, local area networks, wide area networks, the Internet, etc. In some embodiments, one or more of the elements of the computing device 800 communicate via wired or wireless communications. In some embodiments, the transceiver 815 provides an interface for presenting information from the computing device 800 to external systems, users, or memory. For example, the transceiver 815 may include an interface to a display, a printer, a speaker, etc. In an illustrative embodiment, the transceiver 815 may also include alarm/indicator lights, a network interface, a disk drive, a computer memory device, etc. In an illustrative embodiment, the transceiver 815 can receive information from external systems, users, memory, etc.

In an illustrative embodiment, the user interface 820 is configured to receive and/or provide information from/to a user. The user interface 820 can be any suitable user interface. The user interface 820 can be an interface for receiving user input and/or machine instructions for entry into the computing device 800. The user interface 820 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as a user, to enter information into the computing device 800. The user interface 820 can be used to navigate menus, adjust options, adjust settings, adjust display, etc.

The user interface 820 can be configured to provide an interface for presenting information from the computing device 800 to external systems, users, memory, etc. For example, the user interface 820 can include an interface for a display, a printer, a speaker, alarm/indicator lights, a network interface, a disk drive, a computer memory device, etc. The user interface 820 can include a color display, a cathode-ray tube (CRT), a liquid crystal display (LCD), a plasma display, an organic light-emitting diode (OLED) display, etc.

In an illustrative embodiment, the power source 825 is configured to provide electrical power to one or more elements of the computing device 800. In some embodiments, the power source 825 includes an alternating power source, such as available line voltage (e.g., 120 Volts alternating current at 60 Hertz in the United States). The power source 825 can include one or more transformers, rectifiers, etc. to convert electrical power into power useable by the one or more elements of the computing device 800, such as 1.5 Volts, 8 Volts, 12 Volts, 24 Volts, etc. The power source 825 can include one or more batteries.

In an illustrative embodiment, the computing device 800 includes a magnetometer 830. In other embodiments, magnetometer 830 is an independent device and is not integrated into the computing device 800. The magnetometer 830 can be configured to measure magnetic fields. For example, the magnetometer 830 can be the magnetometer 125 or any suitable magnetometer. The magnetometer 830 can communicate with one or more of the other components of the computing device 800 such as the processor 805, the memory 810, etc. A signal from the magnetometer 830 can be used to determine the strength and/or direction of the magnetic field applied to the magnetometer 830.

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
an acoustic transmitter configured to transmit an acoustic signal through a fluid with dissolved ions; and
a magnetometer configured to detect the acoustic signal through the fluid.

2. The system of claim 1, further comprising a vessel that is configured travel through the fluid, and wherein the vessel comprises the transmitter and the magnetometer.

3. The system of claim 2, wherein the vessel is a ship or a boat.

4. The system of claim 2, wherein the vessel comprises a hull, and wherein the magnetometer is located on an inside surface of the hull.

5. The system of claim 2, wherein the vessel comprises a hull, and wherein the magnetometer is located on an outside surface of the hull.

6. The system of claim 2, wherein the vessel comprises a hull, and wherein the magnetometer is located within the hull.

7. The system of claim 1, wherein the acoustic signal causes the dissolved ions to move, and wherein to detect the acoustic signal, the magnetometer is configured to detect the movement of the dissolved ions.

8. The system of claim 1, wherein the magnetometer is configured to determine a direction of the acoustic signal based on a direction of a magnetic field generated by the dissolved ions.

9. The system of claim 1, further comprising a magnetic source that is configured to generate a magnetic field, and wherein the dissolved ions are in the magnetic field.

10. The system of claim 9, wherein the magnetic source comprises a permanent magnet.

11. The system of claim 9, wherein the magnetic source comprises an electromagnet.

12. The system of claim 9, wherein the magnetic source is mounted to the hull.

13. The system of claim 1, wherein the magnetometer comprises a diamond with nitrogen vacancy.

14. A system comprising:
an acoustic transmitter configured to transmit an acoustic signal through a fluid with dissolved ions; and
an array of magnetometers that is configured to detect the acoustic signal through the fluid.

15. The system of claim 14, further comprising a vessel that is configured travel through the fluid, and wherein the vessel comprises the transmitter and the array of magnetometers.

16. The system of claim 14, wherein each magnetometer of the array of magnetometers comprises a diamond with a nitrogen vacancies.

17. The system of claim 14, wherein the array of magnetometers is configured to determine a direction of a magnetic field generated by the dissolved ions.

18. The system of claim 15, wherein the array of magnetometers comprises a plurality of magnetometers arranged in a line.

19. The system of claim 15, wherein the array of magnetometers comprises a plurality of magnetometers arranged in a circle.

20. The system of claim 15, wherein the array of magnetometers comprises a plurality of magnetometers arranged in a grid pattern.

21. The system of claim 15, wherein the acoustic signal causes the dissolved ions to move, and wherein to detect the acoustic signal, the array of magnetometers is configured to detect the movement of the dissolved ions.

22. A method comprising:
transmitting an acoustic signal through a fluid with dissolved ions;
detecting, using a magnetometer, the acoustic signal.

23. The method of claim 21, wherein detecting the acoustic signal comprises detecting a magnetic field created by movement of the dissolved ions.

24. The method of claim 22, wherein the movement of the dissolved ions is created by the acoustic signal.

25. The method of claim 21, wherein said detecting the acoustic signal is performed with an array of magnetometers.

26. The method of claim 21, further comprising determining an angle that the acoustic signal travels by determining a direction of a magnetic field generated by movement of the dissolved ions.

27. The method of claim 21, further comprising providing a magnetic field around the dissolved ions.

28. The method of claim 26, wherein the magnetic field is generated by a permanent magnet.

29. The method of claim 21, further comprising generating a magnetic field around the dissolved ions.

30. The method of claim 28, wherein the magnetic field is generated via an electromagnet.

31. A device comprising a magnetometer that is configured to determine a characteristic of an acoustic signal, wherein the acoustic signal travels through a fluid with dissolved ions.

32. The device of claim 30, wherein the magnetometer is configured to determine the characteristic of the acoustic signal by detecting a magnetic field generated by the dissolved ions.

33. The device of claim 30, wherein the characteristic of the acoustic signal is a magnitude of the acoustic signal.

34. The device of claim 30, wherein the characteristic of the acoustic signal is a frequency of the acoustic signal.

35. The device of claim 30, wherein the device is mounted to a first vessel, and wherein the acoustic signal is generated by a second vessel.
